(19) United States
(12) Patent Application Publication
(10) Pub. No.: US 2015/0031246 A1
(43) Pub. Date: Jan. 29, 2015

(54) CABLE ELECTRICAL CONNECTOR ASSEMBLY HAVING AN INSULATIVE ENCLOSING BODY WITH AN OPENING

(71) Applicant: HON HAI PRECISION INDUSTRY CO., LTD., New Taipei (TW)

(72) Inventors: JERRY WU, Irvine, CA (US); JUN CHEN, Kunshan (CN); FAN-BO MENG, Kunshan (CN)

(21) Appl. No.: 14/340,841

(22) Filed: Jul. 25, 2014

(30) Foreign Application Priority Data
Jul. 26, 2013 (CN) 2013103181790

(51) Int. Cl. H01R 24/60; H01R 43/26; H01R 43/20; H01R 13/46; H01R 43/18

(52) U.S. Cl. CPC H01R 24/60; H01R 13/46; H01R 43/18; H01R 43/205; H01R 43/26
USPC 439/660; 29/879

(57) ABSTRACT

A cable electrical connector assembly includes an electrical connector including a plurality of conductive elements, a cable connecting with the electrical connector and having a number of core wires soldering with the conductive elements, and an insulative enclosing body enclosing the core wires and the conductive elements. The insulative enclosing body has at least one opening above a soldering area of the core wires and the conductive elements. The opening improves impedance in the soldering area of the core wires and the conductive elements.

### BACKGROUND OF THE INVENTION

1. Field of the Invention

The present invention relates to a cable electrical connector assembly and especially relates to a cable electrical connector assembly for high speed transmission.

2. Description of Related Art

U.S. Pat. No. 8,599,567 discloses a cable electrical connector assembly including an electrical connector and a cable connecting with the electrical connector. The electrical connector includes a printed circuit board. The cable has a number of core wires electrically connecting with conductive pads on the printed circuit board and an insulative body enclosing a region where the core wires and the conductive pads are connected. Due to solders present in areas between the core wires and the conductive pads and a higher dielectric constant of the insulative enclosing body than air, impedance increases in such areas. High frequency performance of the cable electrical connector assembly is thus affected.

An improved cable electrical connector assembly is desired.

### SUMMARY OF THE INVENTION

Accordingly, an object of the present invention is to provide a cable electrical connector assembly having a good high frequency performance.

In order to achieve the object set forth, the invention provides a cable electrical connector assembly including an electrical connector having a plurality of conductive elements, a cable connecting with the electrical connector and having a plurality of core wires soldering with the conductive elements, and an insulative enclosing body enclosing the core wire and the conductive elements. The insulative enclosing body has at least one opening above a soldering area of the core wires and the conductive elements.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a cable electrical connector assembly according to a first embodiment of the present invention;

FIG. 2 is a partly exploded view of the cable electrical connector assembly as shown in the FIG. 1;

FIG. 3 is a partly exploded view of some elements of the cable electrical connector assembly as shown in FIG. 1;

FIG. 4 is a perspective view of a cable electrical connector assembly according to a second embodiment of the present invention;

FIG. 5 is a partly exploded view of the cable electrical connector assembly as shown in the in FIG. 4; and

FIG. 6 is a partly exploded view of some elements of the cable electrical connector assembly as shown in FIG. 4.

### DETAILED DESCRIPTION OF THE PREFERRED EMBODIMENT

Reference will now be made in detail to the preferred embodiment of the present invention.

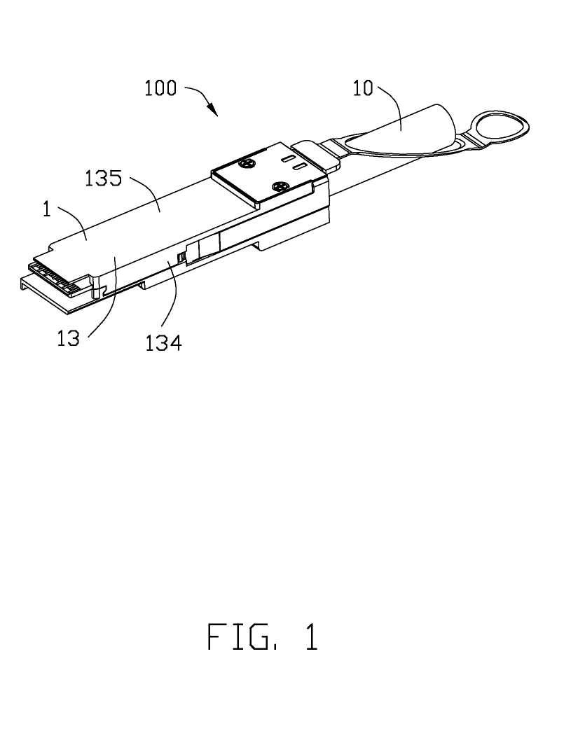

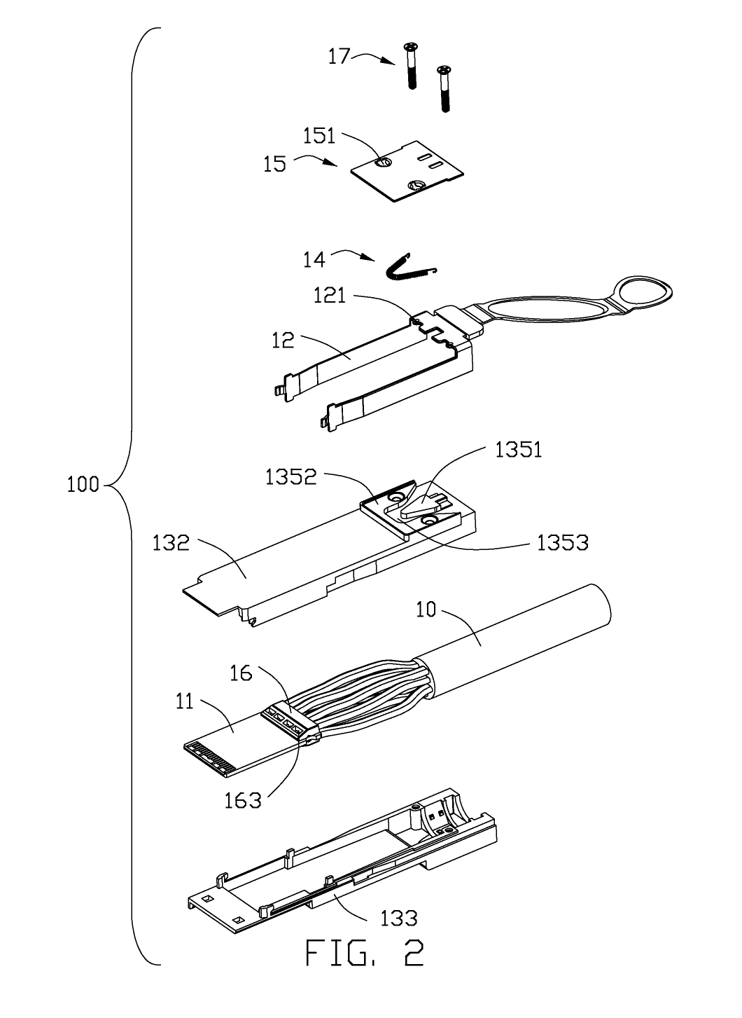

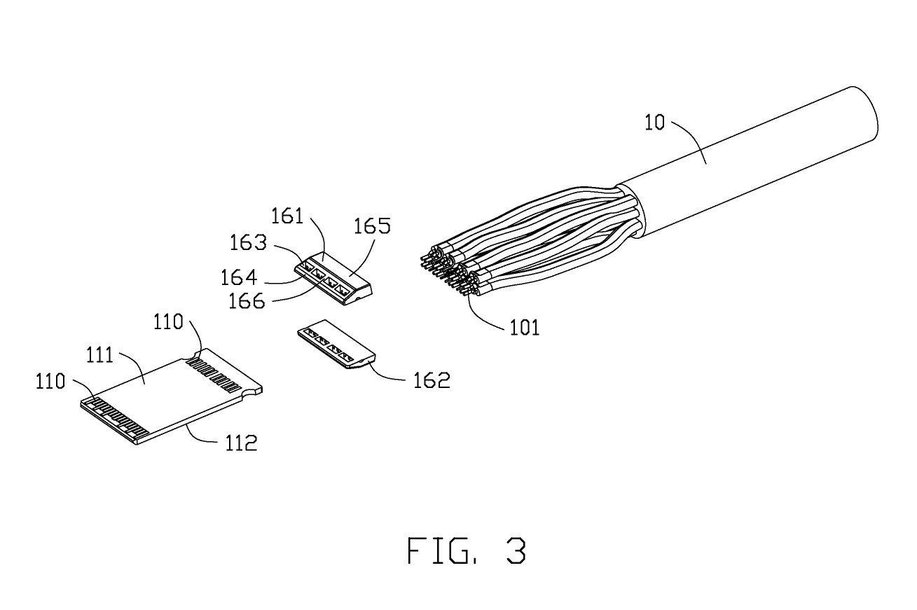

Referring to FIG. 1 to FIG. 3, a cable electrical connector assembly 100 includes an electrical connector 1 and a cable 2 connecting with one side of the electrical connector 1. The cable electrical connector assembly 100 is a first embodiment.

The electrical connector 1 includes a number of conductive elements, a shell 13, and an unlocking mechanism 12 mounted on the shell 13. The shell 13 includes an upper shell 132 and a lower shell 133 cooperating with the upper shell 132. The upper shell 132 and the lower shell 133 are fixed together by a holder 17. In this embodiment, the holder 17 is a screw.

The electrical connector 1 also includes a printed circuit board 11. The printed circuit board 11 has an obverse 111 and a reverse 112. The conductive elements are some conductive pads 110 mounted on the obverse 111 and the reverse 112 of the printed circuit board 11. Some of the conductive pads 110 are welded with the cable 2. The shell 13 also has two side walls 134 and a top wall 135 perpendicular to the side wall 134.

The top wall 135 of the shell 13 has a resistant portion 1351 and a tuber 1352. The tuber 1352 is spaced apart from the resistant portion 1351 and forms a receiving slot 1353. The electrical connector 1 further includes a stretchable elastic member 14. In this embodiment, the elastic member 14 is a spring. The elastic member 14 is bent to a V-shape and received in the receiving slot 1353. Unlocking mechanism 12 has two holes 121 connecting with ends of the elastic member 14. When the unlocking mechanism 12 is moved backward by an external force, the elastic member 14 resists on the resistant potion 1351 and the elastic member 14 is stretched. After removing the external force 14, the unlocking mechanism 12 is forwardly moved to an initial position by the elastic restoring force of the elastic member 14. The electrical connector 1 further includes a cover plate 15 covering the elastic member 14. The cover plate 15 has a resistant hole 151 for mechanically connecting with the holder 17.

The cable 10 includes a number of core wires 101. The core wires 101 are soldered with the conductive pads 110 on the obverse 111 and the reverse 112 of the printed circuit board 11.

The cable electrical connector assembly 100 further includes an insulative enclosing body 16 enclosing the connection of the core wire 101 and printed circuit board 11. The insulative enclosing body 16 strengthens the retention in the soldering area of the cable 10 and the printed circuit board 11. The insulative enclosing body 16 is an insulating material with a low melting point. The insulative enclosing body 16 is low pressure injection molded with the conductive pads 110 and the cable 10. The insulative enclosing body 16 includes a first insulative body 161 and a second insulative body 162. The first insulative body 161 is same as the second insulative body 162. The first insulative body 161 and the second insulative body 162 respectively cover on the obverse 111 and the reverse 112. The insulative enclosing body 16 has one or more openings 163 above the soldering area. The opening 163 extends through the insulative enclosing body 16 in a vertical direction. The core wires 101 comprise a plurality of differential signal pairs and the opening 163 is hollowed above the differential signal pair.

The insulative enclosing body 16 has a first portion 164 in front of the opening 163 and a second portion 165 behind the opening 163. The first portion 164 is lower than the second portion 165. If the insulative enclosing body 16 has a number of openings 163, a rib 166 is between every two openings 163.

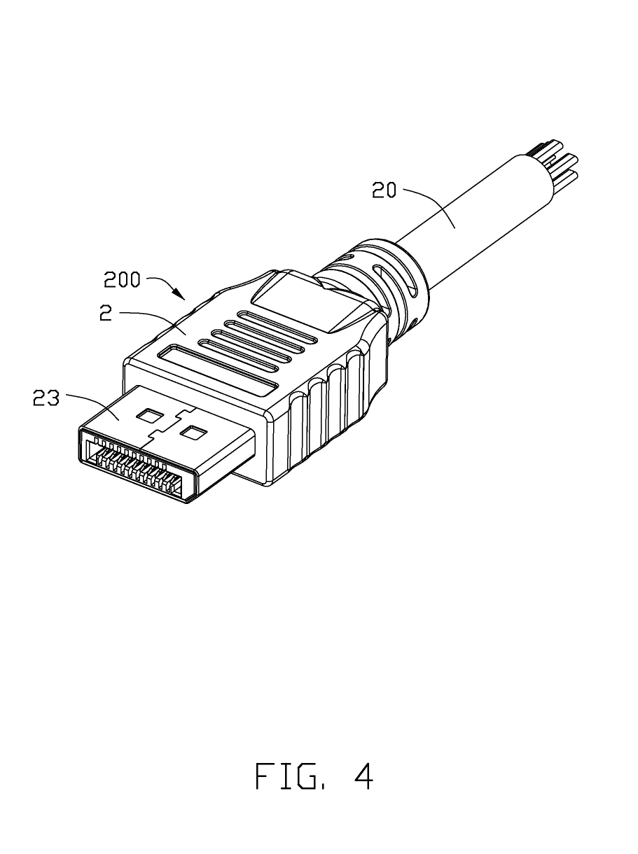

Referring to FIG. 4 to FIG. 6, a cable electrical connector assembly 200 includes an electrical connector 2 and a cable 20 connecting with one side of the electrical connector 2. The cable electrical connector assembly 200 is a second embodiment.

The electrical connector 2 includes an insulative housing 22, a number of conductive terminals 21 arranged in a transverse direction, and a metal shell 23 enclosing the insulative housing 22 and an insulative shell 24 receiving the metal shell 23. The conductive terminal 21 is a conductive path of the electrical connector 2.

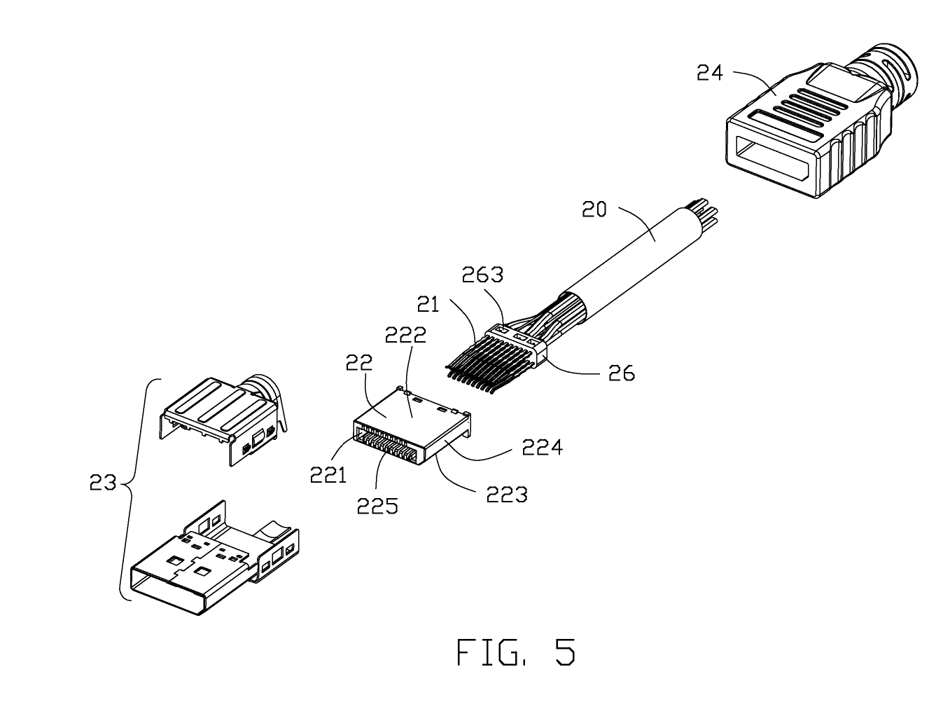

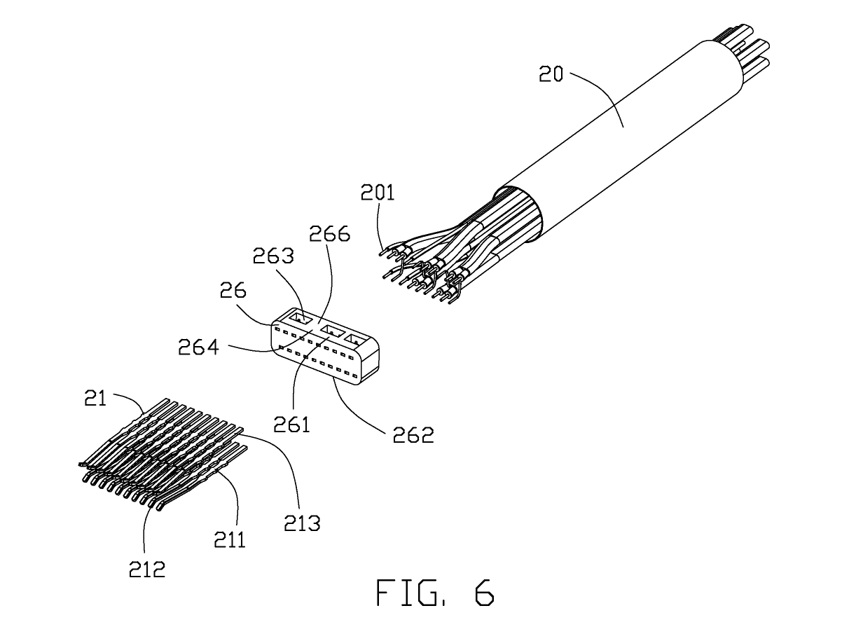

Referring to FIG. 5 to FIG. 6, the insulative housing 22 is rectanglar. The insulative housing 22 includes an upper wall 222, a lower wall 223, and two said walls 224, together enclosing a receiving space 221. Each of the upper wall 222 and the lower wall 223 defines a number of terminal receiving passageways 225. The conductive terminals 21 are received in the terminal receiving passageways 225. The terminals 21 form two rows. The two rows of terminals 21 are spaced apart along an up-to-down direction. A mating connector is inserted between the two rows terminals 21.

The conductive terminal 21 includes a main portion 211, a mating portion 212, and a soldering portion 213. The soldering portion 213 extends beyond the insulative housing 22 for soldering with core wires 201 of the cable 20.

The cable electrical connector assembly 200 includes an insuletive enclosing body 26 enclosing the core wire 201 and the conductive terminal 21. The insulative enclosing body 26 can strengthen the retention in the soldering area of the core wire 201 and the conductive terminal 21. The insulative enclosing body 26 has at least one opening 263 above the soldering area. The opening 263 through the insulative enclosing body 26 in a vertical direction. The core wire 201 comprising a plurality of differential signal pairs, each of the openings 263 is hollowed above the differential signal pair. The insulative enclosing body 26 is an insulating material with low melting point. The insulative enclosing body 26 is low pressure injected molding with the conductive terminals 21 and the cable 20.

The insulative enclosing body 26 has an upper wall 261 and a lower wall 262 and at least an opening 263 defined on the upper wall 261 and the lower wall 262. The opening 263 extends along the transverse direction. When there is a number of openings 263, a rib 266 is formed between every two adjacent openings 263.

Due to solder in the soldering area and a higher dielectric constant of the insulative enclosing body 16,26, impedance increases in the soldering area. The present invention designs the openings 163,263 in the insulative enclosing body 16,26 for exposing to ambient air. Because of the dielectric constant of air is less than the dielectric constant of the insulative material, the impedance in the soldering area is improved. The openings 163,263 are hollowed above the differential signal pairs to reduce capacitance of the differential signal pairs. The design improves the high frequency performance of the cable electrical connector assembly 100,200.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the members in which the appended claims are expressed.

What is claimed is:

1. A cable electrical connector assembly comprising:
an electrical connector comprising a plurality of conductive elements;
a cable connecting with the electrical connector and comprising a plurality of core wires soldering with the conductive elements;
an insulative enclosing body enclosing the core wires and the conductive elements, the insulative body having at least one opening above a soldering area of the core wires and the conductive elements.

2. The cable electrical connector assembly as claimed in claim 1, wherein the at least one opening extends through the insulative enclosing body in a vertical direction.

3. The cable electrical connector assembly as claimed in claim 1, wherein the plurality of core wires comprise a plurality of differential signal pairs, and the at least one opening is hollowed above the differential signal pair.

4. The cable electrical connector assembly as claimed in claim 1, wherein the insulative enclosing body is low pressure injected molding with the conductive elements and the cable.

5. The cable electrical connector assembly as claimed in claim 1, wherein the electrical connector comprises a printed circuit board, and the conductive elements are conductive paths on the printed circuit board.

6. The cable electrical connector assembly as claimed in claim 5, wherein the printed circuit board has an obverse and a reverse, and the insulative enclosing body has a first insulative body covering the obverse and a second insulative body covering the reverse.

7. The cable electrical connector assembly as claimed in claim 1, wherein the electrical connector comprises a plurality of contacts constituting the conductive elements, and the insulative enclosing body encloses the core wires and the contacts.

8. The cable electrical connector assembly as claimed in claim 7, further comprises an insulative housing having a receiving space, and the contact has a tail extending forwardly beyond the receiving space to solder with the core wire.

9. The cable electrical connector assembly as claimed in claim 1, wherein the insulative enclosing body has a first portion in front of the at least one opening, a second portion behind the at least one opening, and a rib between the two openings, and the first portion is lower than the second portion.

10. The cable electrical connector assembly as claimed in claim 1, wherein the at least one opening is defined in a transverse direction.

11. A cable connector assembly comprising:
a housing enclosing a plurality of conductive element in a stationary manner;
a plurality of wires including inner conductors with exposed front sections soldered to the conductive elements, respectively; and
an insulative body generally enclosing around the exposed front sections of the inner conductors and the corresponding conductive elements to not only unify the spread wires but also protect solder regions between the inner conductors and the conductive elements; wherein
a plurality of openings are formed in the insulative body to communicate the soldered exposed front sections of the inner conductors and the corresponding conductive elements to an exterior, respectively, for increasing impedance thereabouts.

12. The cable connector assembly as claimed in claim 11, wherein the conductive element is a tail section of an electrical contact.

13. The cable connector assembly as claimed in claim 12, wherein the insulative body encloses the conductive element circumferentially.

14. The cable connector assembly as claimed in claim 11, wherein the conductive element is a pad on a surface of a printed circuit board.

15. The cable connector assembly as claimed in claim 14, wherein the insulative body covers the surface around said pad.

16. The cable connector assembly as claimed in claim 11, wherein said openings upwardly communicate the solder regions to the exterior in a vertical direction.

17. A method of assembling an cable connector assembly comprising:
providing a plurality of conductive elements in a stationary manner;
providing a plurality of wires each with an exposed front section of an inner conductor;
soldering the exposed front section of the inner conductor to the conductive element to form a joint region for each pair of said conductive element and the corresponding wire;
applying an insulative body around all the joint regions to not only unify the wires but also protect the joint regions; and
forming a plurality of openings in the insulative body to communicate the joint regions with an exterior.

18. The method as claimed in claim 17, wherein the said conductive element is a tail of an electrical connector.

19. The method as claimed in claim 17, wherein said conductive element is a pad formed on a surface of a printed circuit board.

20. The method as claimed in claim 17, wherein the insulative body fully circumferentially surrounds the corresponding joint regions.
